(19) United States
(12) Patent Application Publication
(10) Pub. No.: US 2007/0009861 A1
(43) Pub. Date: Jan. 11, 2007

(54) Simulator

(76) Inventor: Harald Heinrich, Osseltshausen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/146,194

(22) Filed: Jun. 6, 2005

(30) Foreign Application Priority Data
Jun. 11, 2004 (DE) 10 2004 028 261.7

(51) Int. Cl. G09B 9/02

(52) U.S. Cl. 434/29

(57) ABSTRACT

A simulator with a manipulator having several rotation axes and a seat unit fixed to the manipulator hand flange is proposed, in which there is at least one screen movable between a display position in front of the seat unit and an entry and exit position enabling entry to the seat unit.

### FIELD OF THE INVENTION

The invention relates to a simulator with a manipulator having several rotation axes and a seat unit fixed to a hand flange of the manipulator.

### BACKGROUND OF THE INVENTION

The simulator according to the invention can be used as any type of simulator, namely as a flight simulator, motor vehicle simulator, etc.

Besides kinematics for the movement of the seat units, known simulators have a display screen, which is generally a monitor, as well as an electroacoustic reproduction system. The seat unit for persons using the manipulator is generally constructed as a closed cabin with integrated display screen. The space conditions are generally very constricted and entry and exit is far from easy. The confined spatial conditions require a complicated venting and ventilating system and restrict the passenger.

Therefore the problem of the invention is to create a simulator based on a multiaxial or multiaxle manipulator which, whilst avoiding the aforementioned disadvantages, allows easy entry and exit.

### SUMMARY OF THE INVENTION

In the case of a simulator of the aforementioned type, the invention solves the set problem in that there is at least one screen movable between a display position in front of the seat unit and an entry and exit position allowing entry to the seat unit.

The solution according to the invention creates a simulator which on moving the display screen into its entry and exit position permits easy entry and exit, but in the operating or display position allows optimum simulation to take place.

According to a preferred development of the invention, the display screen is an optoelectronic monitor, which is either a LCD monitor or a polymer display.

In an alternative development the display screen can be constructed as a projection screen and in this case there is a video projector in the form of a beamer or a laser projector, which projects the scenery onto the projection screen. The display screen can be flat or partly spherical. The projection screen can be made from foldable material or fibre-reinforced plastic.

The screen is mechanically decoupled from the projection unit, i.e. the latter can be moved separately from the screen. This leads to a vibration-neutralization and the projection unit position with respect to the screen can be set in optimum manner. Thus, vibrations of the screen are not transmitted to the projector. The projector fixing can be made more rigid. The observer will not notice slight screen vibration, whereas a projector movement and therefore an image movement are considered irritating.

The projection screen can be constructed in foldable manner in a preferred development, e.g. in the form of a fold up screen (Knirps principle) or with curved lamellas unfolding the same and which can be pivoted about a pivot point from a closed into an open position and vice versa.

According to an alternative development the display screen, either as an electrooptical monitor or projection screen, is pivotable and can be pivotably articulated to the seat unit or directly articulated to the manipulator hand flange. One or more pivot pins can be provided. Pivoting can take place about an axis substantially perpendicular to the extension direction of the backs of the seat unit or in the extension thereof or about several axes. Intermediate positions are also possible, so that there is a sloping pivoting away of the display screen.

According to a preferred development the display screen is held in a display position in an abutment and it is preferably formed by a slot or pin connection. The display screen can also be locked in the display position and this can be brought about by a transverse locking means, in which the locking mechanism has a reception part and a plug-in part, which can be firmly joined together by a lokking pin which can be passed vertically through the same. Alternatively it is possible to have a locking mechanism with an abutting surface and a recess-equipped locking rod and a hook-like rocking lever, which is pretensioned in spring-loaded manner towards the locking rod. Alternatively it is possible to provide other locking systems, such as a retaining pawl, an eccentric belt or a magnetic locking means. The locking mechanism can have a reception part and a locking pin provided with a signal pin, locking being brought about by a contact pressure, in that a pivot drive for the display screen has an initial torque, which permits a secure fixing of the screen, particularly in the pivoted in position, but also in the releasing position. For support purposes the drive elements can have a self-locking means or a standstill brake can be provided. Locking monitoring can take place by a sensor.

The display screen can be pivoted manually or by a drive, such as an electromotive drive or a hydraulic or gas cylinder drive.

According to another preferred development, there is a sound reproduction system associated with the seat unit and can be in the form of a surround sound system. The public address system is controlled by an amplifier supplied by means of optical waveguides or conventional cable technology with digital or analog data. Loudspeaker response can be adapted in optimum manner by holding systems to the seats.

The seat unit can be entered from the front or side, optionally as a function of the design of the entry point and the display screen.

### BRIEF DESCRIPTION OF THE DRAWINGS

Further advantages and features of the invention can be gathered from the claims, the following description of embodiments of the invention and the attached drawings, wherein show:

FIGS. 1 & 2 A first embodiment of an inventive simulator with a fold up projection screen.

FIG. 3 An isolated representation of the seat unit with projection screens of FIGS. 1 and 2.

FIGS. 4 & 5 A further seat unit with a projection screen constructed as a fold up screen.

FIG. 6 A seat unit with a darkening screen at the rear.

FIGS. 7 & 8 An inventive simulator with seat unit and pivotable screen.

FIGS. 9-11 A first embodiment of a locking arrangement for a pivotable screen.

FIG. 12 Another locking mechanism.

FIG. 13 A further locking mechanism.

FIGS. 14 & 15 Another embodiment of the inventive simula tor in the entry and exit position (FIG. 14) and playback position (FIG. 15).

FIGS. 16-19 Another embodiment of an inventive seat unit with a lever transmission for pivoting a display screen into the closed position (FIGS. 16, 17) and into the opened position (FIGS. 18, 19).

FIGS. 20-23 Another inventive development of an inventive seat unit with projection screen and projector in a perspective view (FIGS. 20 and 22), as well as front view (FIGS. 21, 23) with pivoted out projector (FIGS. 20, 21) and with the projector pivoted into the operating position (FIG. 22, 23).

### DETAILED DESCRIPTION OF THE DRAWINGS

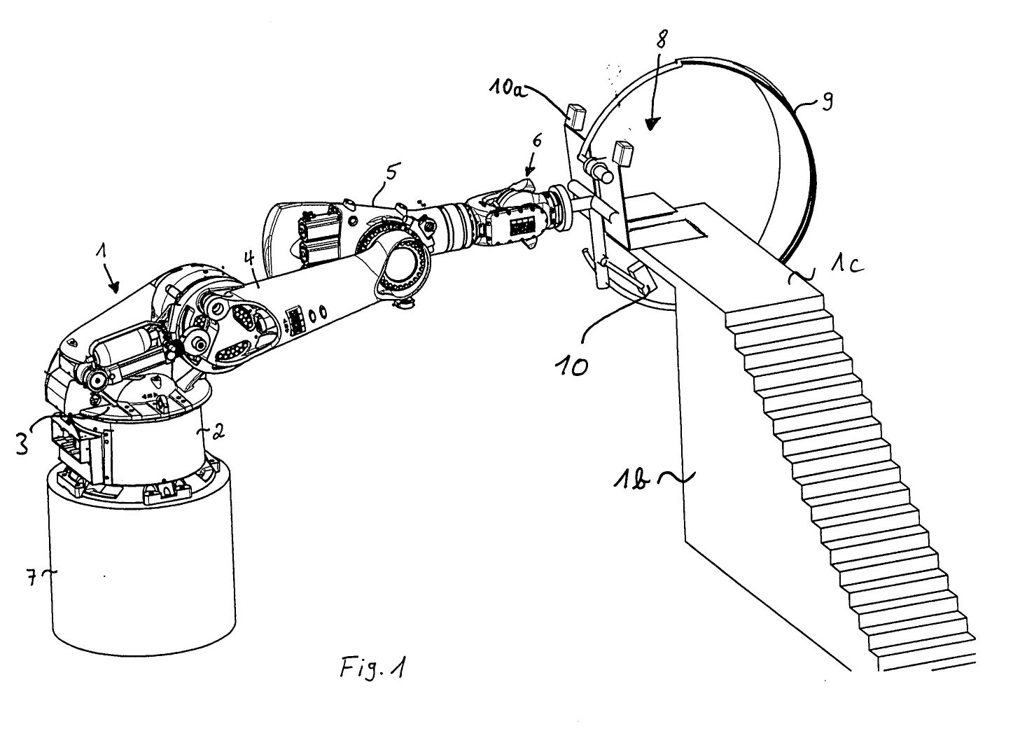

FIGS. 1 and 2 show a first embodiment of an inventive simulator 1 with a manipulator 1a having six rotation axes, the vertical A1 axis about which the manipulator carrousel 3 can be pivoted relative to the base 2, the horizontal A2 and A3 between carrousel 3 and rocker 4 or rocker 4 and manipulator arm 5, as well as the three hand axes A4, A5, A6 of hand 6. The base 2 of manipulator 1 is placed on a stable, fixed base member 7.

A seat unit 8 with two seats is fixed to the hand flange of hand 6 of manipulator 1a. As shown in FIG. 1, access to the seats is provided by steps 1b, which are preferably given a movable construction.

In the embodiment shown a display screen in the form of a projection screen 9 is fixed to the seat unit. The display screen can also be fixed directly to the flange of hand 6 of manipulator 1a. Instead of a projection screen the display screen can also be in the form of an electrooptical monitor.

In the case of the embodiment shown in FIG. 1 a projector 10 is provided, enabling a scene to be projected onto the projection screen 9. The projector 10 can be pivoted into a projection position after moving the seat unit 8 away from its entry platform 1c between the seats of said seat unit 8, on which are also provided loudspeakers 10a.

In FIG. 1 the projection screen 9 is shown in a folded up state, which allows passengers to have access to the seat unit 8 of manipulator 1. In the construction according to FIG. 2 the projection screen 9 is unfolded, so that the projector 10 located above the back area of the seat unit 8 can project an image onto the inside of the projection screen 9.

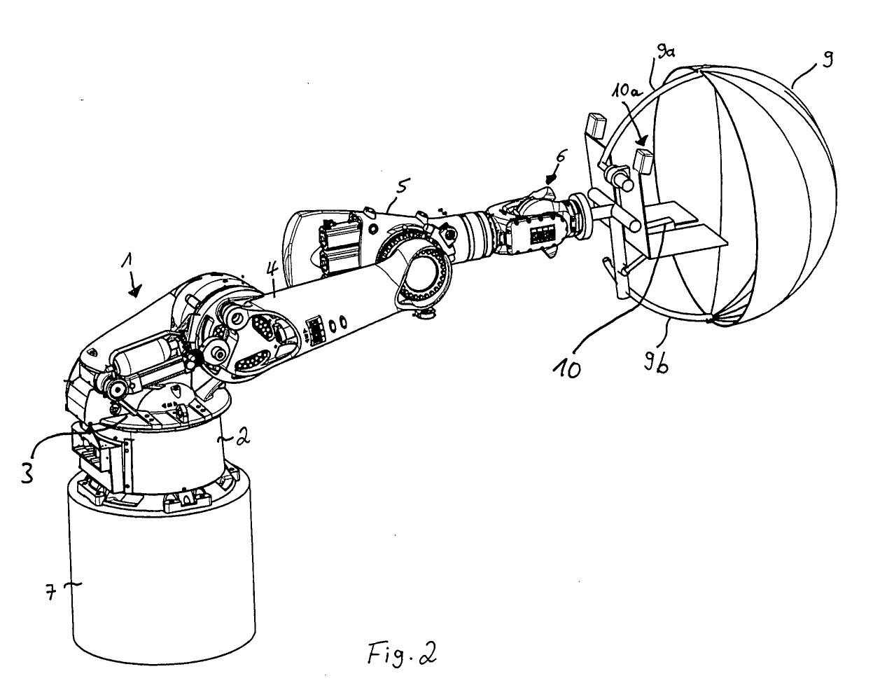

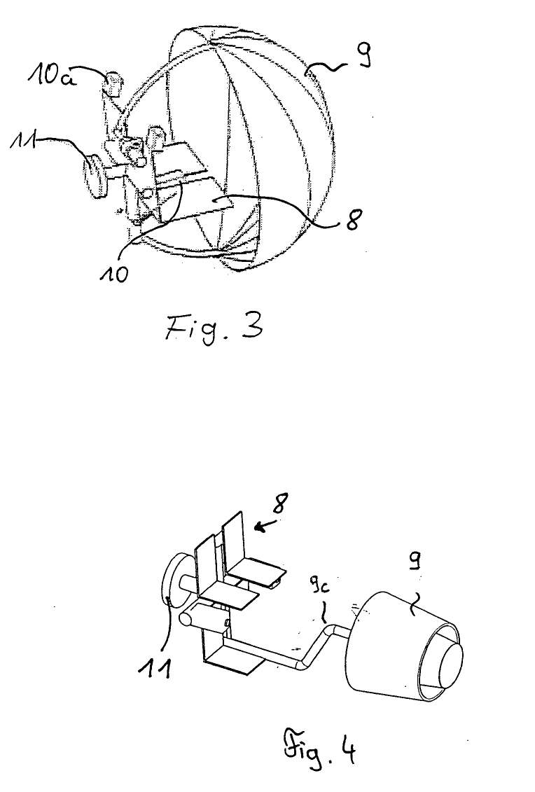

The projection screen 9 is held on the back of the seat unit 8 by two bows 9a, 9b. In this case entry into the seat unit 8 preferably takes place from the side from a platform 1c, via steps 1b. FIG. 3 shows in isolated form the seat unit 8 with projection screen 9. It is possible to see a flange part 11 with which it can be fixed to the flange of the robot hand 6.

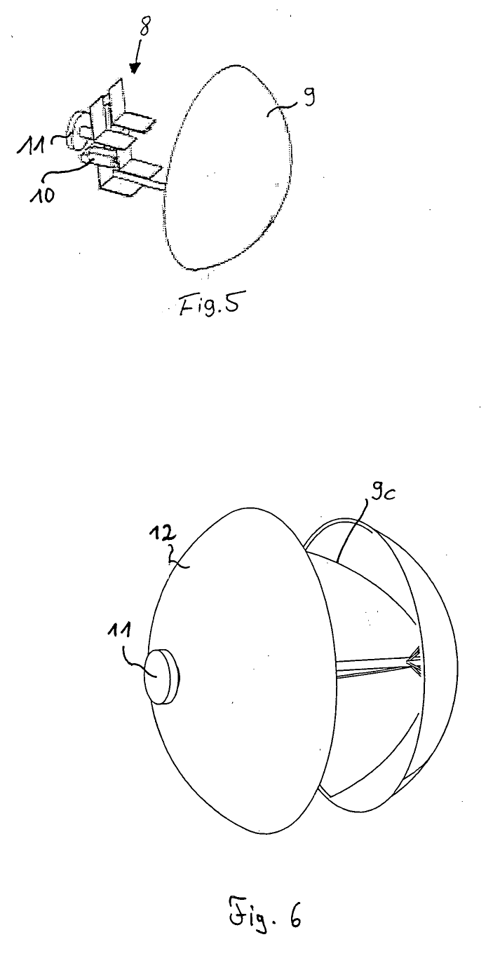

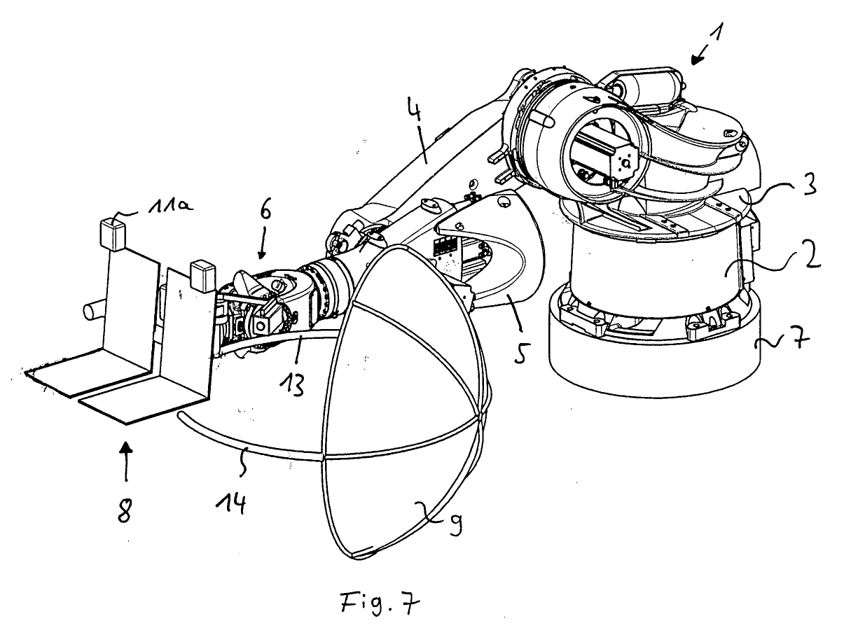

FIGS. 4 and 5 show a further seat unit 8 with projection screen 9 of an inventive manipulator. This seat unit has four seats. The seat unit of FIGS. 1 to 3 can also be equipped with four seats. The projection screen 9 of FIGS. 4 and 5 is constructed in the form of a fold up screen in which the braces 9c (not shown, but on the inside in FIG. 5), which extend radially and unfold the screen can be fixed to the central support rod 9d by means of braces and a parallelogram linkage.

In FIGS. 4 and 5 a projector 10 is positioned laterally of the seat unit. However, it can also be located in the upper area between the two lower seats provided there.

FIG. 6 shows a seat unit, where there is a further screen 12 for extraneous light protection and darkening purposes at the rear behind the seat unit 8. The rear screen 12 is preferably given a fold up construction in the same way as the screen of FIGS. 4 and 5.

The further drawings show permanently unfolded screens pivotable for entry purposes.

FIG. 7 once again shows a manipulator according to the invention, with a seat unit 8 and a pivotable screen 9 in the opened position, the screen 9 being laterally pivoted away. Thus, passengers can sit in the seat unit or leave the same again.

FIG. 8 shows the manipulator of FIG. 7 in plan view from above.

The screen 9 is articulated with the seat unit by means of a pivot bow 13 and can be pivoted manually by means of a joint or by a motor. On the side of the screen 9 remote from the pivot bow 13 is provided a locking bow 14, which in the closed position locks the same. The projector 10 is pivotable about the same pivoting axis as the screen 9. It can be pivoted together with or independently of the screen 9, but is preferably vibration-neutralized with respect to screen 9.

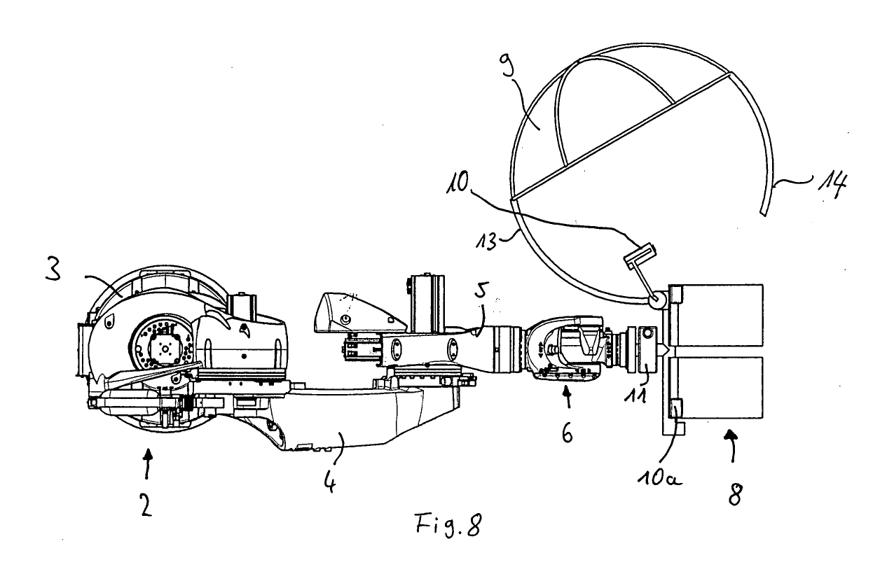

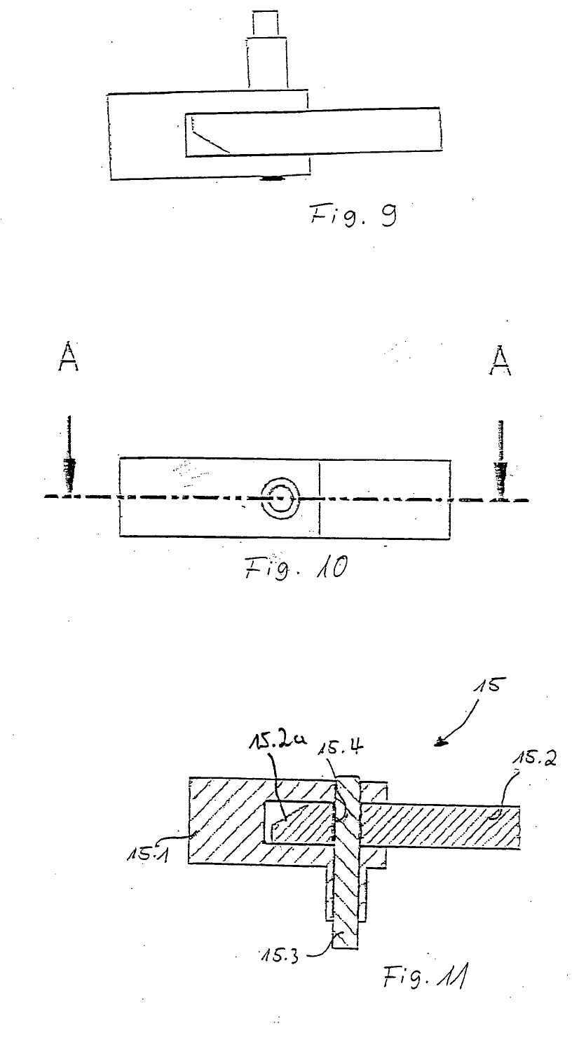

For this purpose an abutment with a locking means 15 is provided at the free end of the locking bow 14, in the manner shown in a first embodiment in FIGS. 9 to 11, namely in FIG. 9 in plan view, in FIG. 10 in side view and FIG. 11 in a section corresponding to A-A in FIG. 10.

The locking means 15 has a reception part 15.1 and a plug-in part 15.2 with a sloping abutting surface 15.1a and a locking pin 15.3. In the plug-in part 15.2 is provided an opening through which can be passed the locking pin following the insertion of the plug-in part 15.2 into the reception part 15.1, so as in this way to lock the two parts 15.1 and 15.2. The drive of the locking pin 15.3 can e.g. be of an electromotive nature. Preferably the reception part 15.1 and locking pin 15.3 are placed on the seat unit 8, whereas the plug-in part 15.2 forms the free end of the locking bow 14.

The association of parts 15.1 and 15.3 on the one hand and part 15.2 on the other with respect to the seat unit 8 and locking bow 14 can also be in the reverse form.

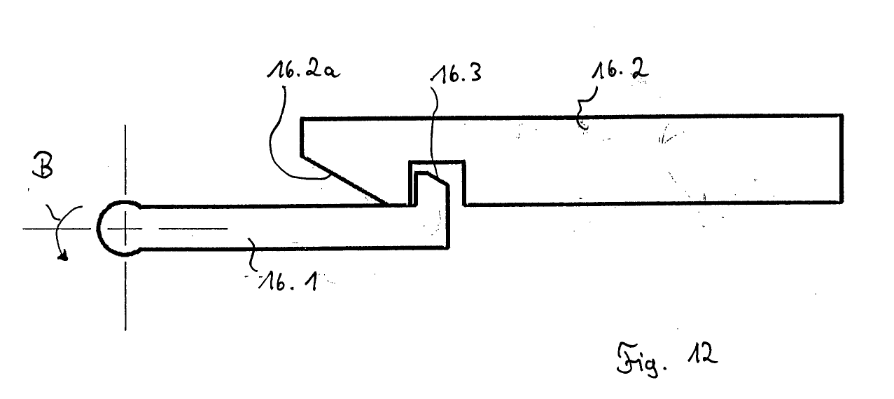

FIG. 12 shows another locking mechanism with a rocking lever 16.1 under an elastic force in the direction of arrow B, e.g. a spring, and a locking bolt 16.2 provided with a lateral recess 16.3 and a sloping abutting surface 16.2a, which can be formed at the free end of the locking bow 14, whereas the bolt 16.2 is formed at the free end of the lokking bow. A reverse arrangement can also be chosen.

FIG. 13 shows another rocking mechanism 17 with a reception part 17.1 and plug-in part 17.2 with a sloping abutting surface 17.2a provided at its front end with a signal pin 17.3. Here locking takes place by guiding the plug-in part 17.2, which is bevelled on its front side, in the reception part 17.1 and a force generator, e.g. a hydraulic cylinder or the like located at the articulated end of the pivoted bow 13.

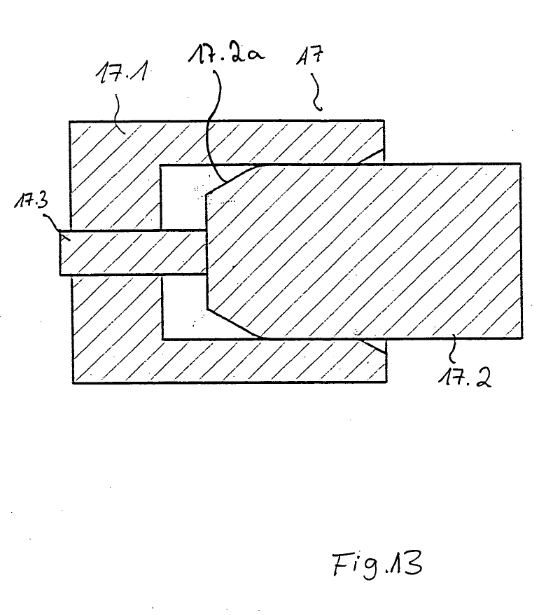

FIGS. 14 and 15 show another embodiment of the inventive simulator, namely in FIG. 14 in the entry and exit position of the projection screen and in FIG. 15 in its closed reproduction or display position. In this embodiment the pivoted bow 13 of projection screen 9 is pivotable about a pivot pin 13a directed perpendicularly to the extension of the seat backs and which is located on the back surfaces of the seat unit 8. The pivoted bow 13 carries a projector 10 and on the projection screen side remote from said bow 13, the screen carries a locking lever 14, which in the manner described relative to FIGS. 11 to 13 can be locked on a foot 8a of the seat unit 8.

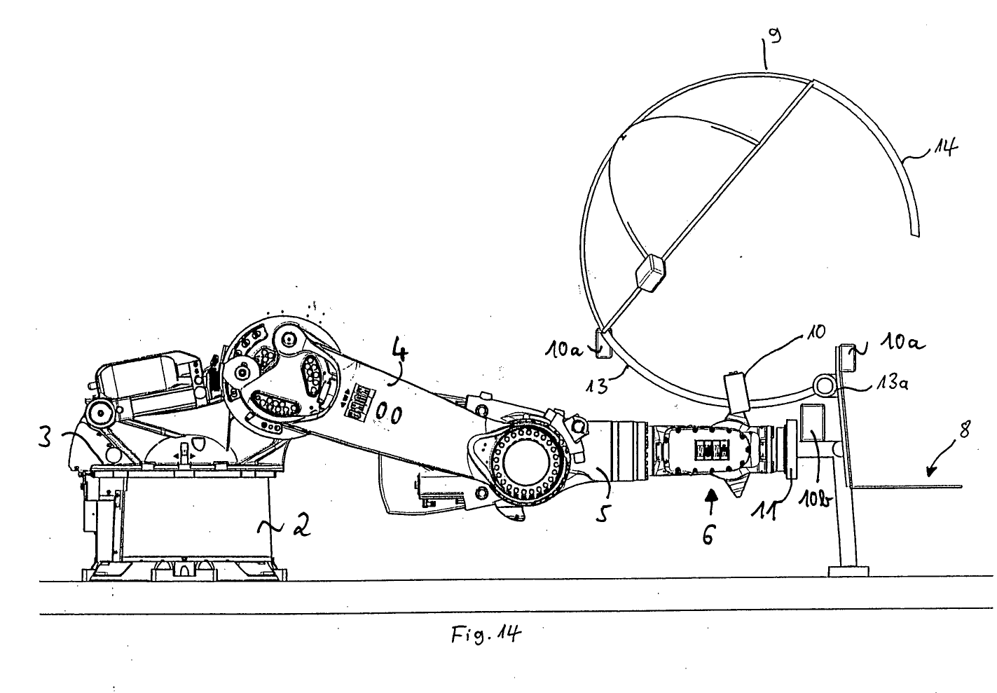

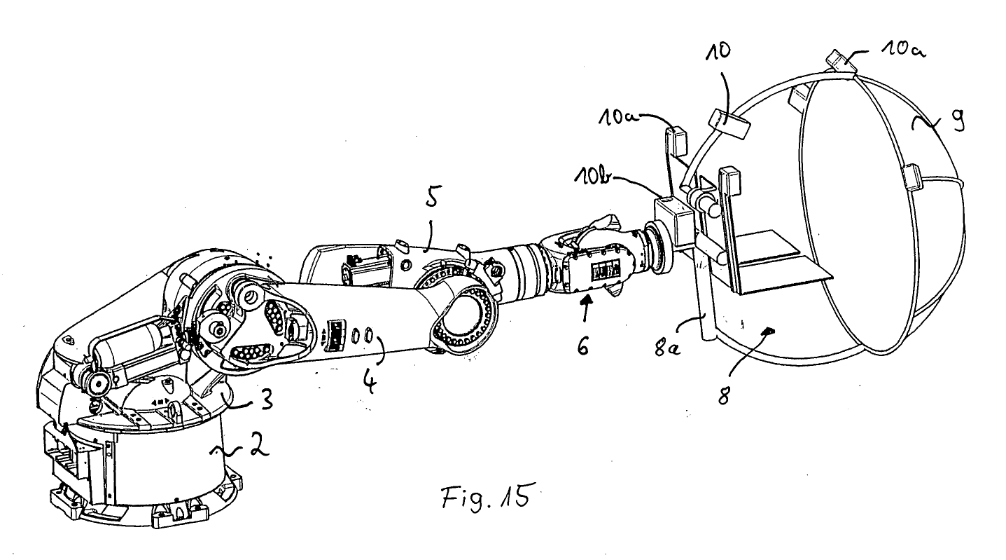

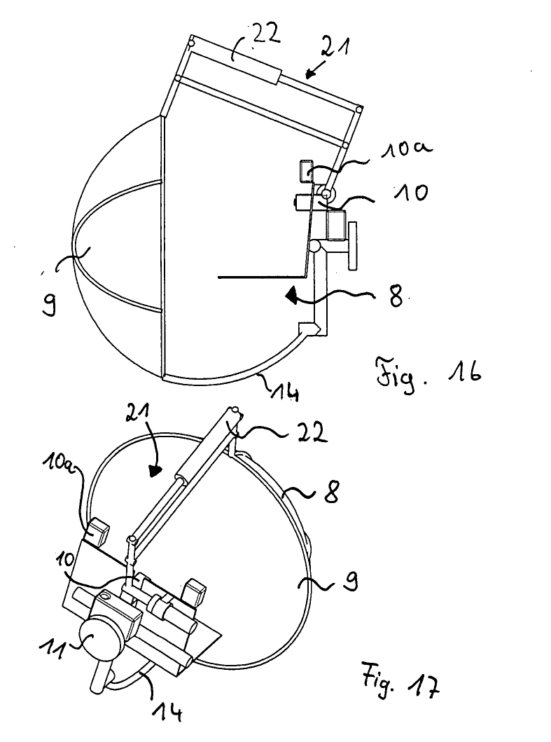

Thus, in the development of FIGS. 14 and 15 the projection screen can be pivoted in the extension direction of the backs of the seat unit 8 (i.e. in the reception position vertically). An amplifier is located at 10b and loudspeakers 10a are provided on screen 9.

Whereas in the previous embodiments of a pivotable screen the latter is only pivotable on an arc about a pivot axis, in the development of FIGS. 16 to 18 there is a projection screen, which can be pivoted by means of a lever transmission 21 with piston-cylinder unit between a closed operating position (FIGS. 16 and 17) and an opened entry and exit position (FIGS. 18 and 19). Here again the locking bow 14 can be locked in the above-described manner.

As in the other described pivoting arrangements for the projection screen, pivoting can here again take place in the extension direction of the backs of seat unit 8, or perpendicular thereto, or at any other random angle, there preferably being a displacement to the side, upwards or sloping upwards.

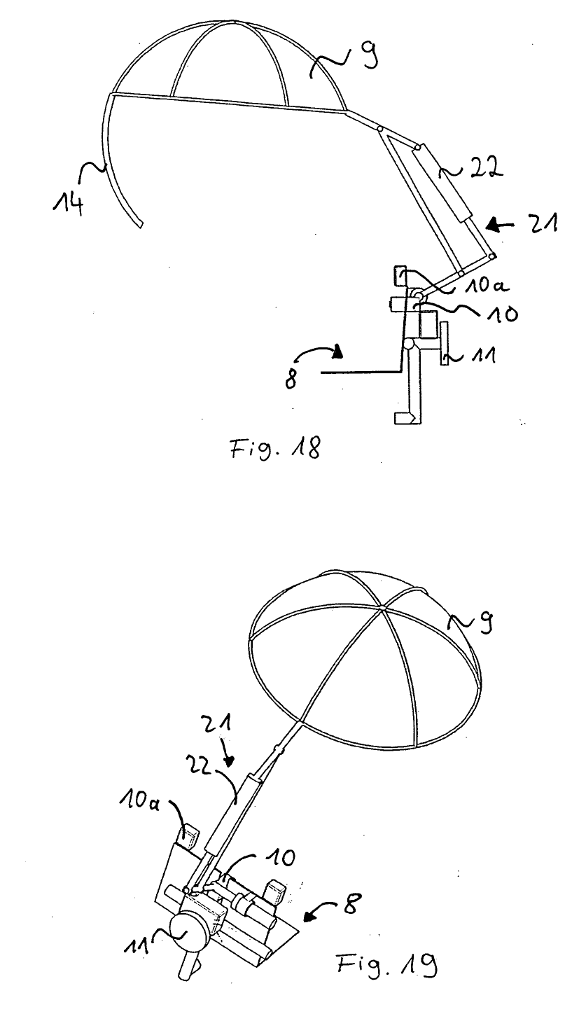

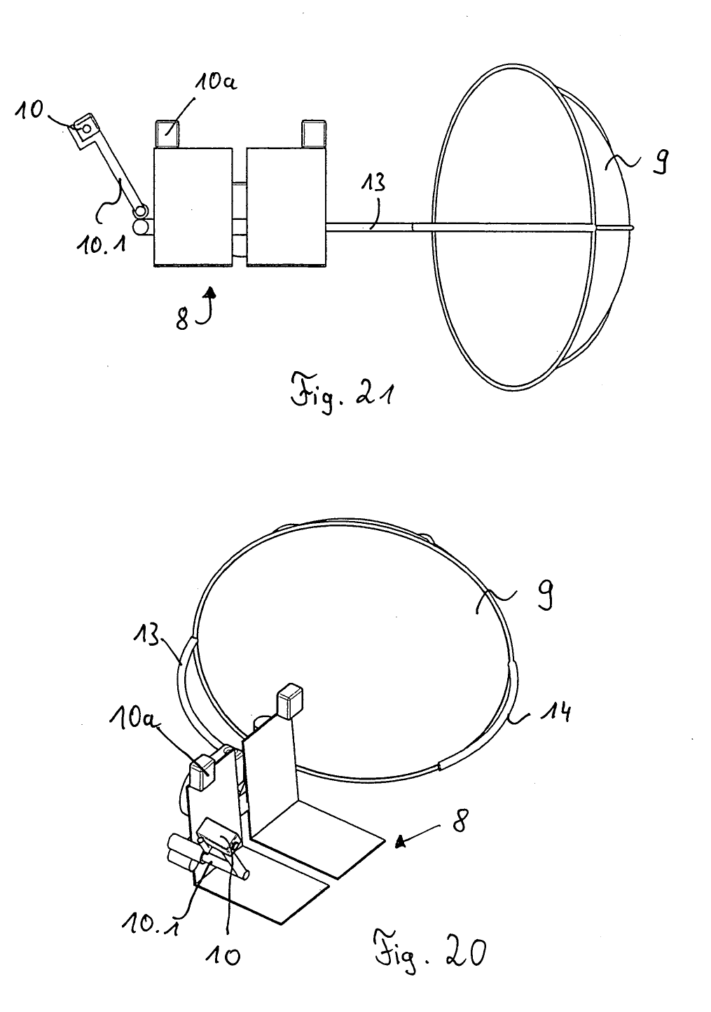

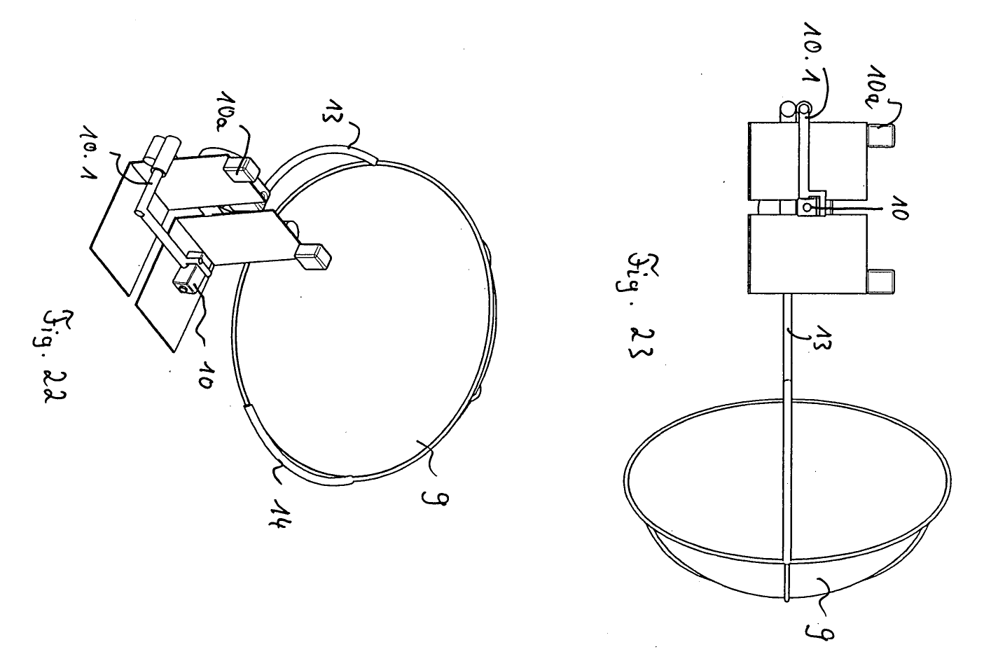

FIGS. 20 to 23 show a further inventive seat unit 8 with projection screen 9 and projector 10. As in the construction according to FIGS. 7 and 8, the projection screen 9 is pivotably articulated to the seat unit (about an axis to the seat plane). The arrangement of the projector 10 differs from that of FIGS. 8 and 9. The projector is fixed to an angularly constructed rocking lever 16.1, which is pivotably laterally articulated in the vicinity of the seat back, so that the projector 10, after the user has occupied the seat, preferably from the front, can be pivoted in with an area between and in front of the two users, as shown in FIGS. 22 and 23. Thus, the projector 10 can be positioned precisely on the axis of symmetry of the projection screen 9, so that there is an optimum, undistorted image reproduction.

In the case of a projection screen, the projection unit can be a data projector (beamer) or a laser projector. A video monitor is preferably constructed as a LCD flat screen or as a flexible polymer display. A spherical or stereo image can be produced.

1. Simulator with a manipulator having several rotation axes and a seat unit fixed to a manipulator hand flange, characterized in that there is at least one display screen movable between a display position in front of the seat unit and an entry and exit position enabling entry to the seat unit.

2. Simulator according to claim 1, wherein the display screen is an optoelectronic monitor.

3. Simulator according to claim 2, wherein the monitor is a LCD monitor.

4. Simulator according to claim 2, wherein the optoelectronic monitor is a polymer display.

5. Simulator according to claim 1, wherein the display screen is a projection screen.

6. Simulator according to claim 1, wherein the display screen is flat.

7. Simulator according to claim 5, wherein the projection screen is partly spherical.

8. Simulator according to claim 6 in conjunction with claim 5, wherein the projection screen is foldable.

9. Simulator according to claim 8, wherein the projection screen is constructed as a fold up screen.

10. Simulator according to claim 8, wherein the projection screen can be folded in lamellar manner.

11. Simulator according to claim 5, wherein the projection screen is made from foldable textile material.

12. Simulator according to claim 5, wherein the projection screen is made from fibre-reinforced plastic.

13. Simulator according to claim 1, wherein the display screen can be pivoted between a display position and a position enabling access to a seat unit.

14. Simulator according to claim 13, wherein the display screen can be pivoted about one or more axes.

15. Simulator according to claim 13, wherein the display screen can be pivoted by hand.

16. Simulator according to claim 13, wherein the display screen is automatically pivotable.

17. Simulator according to claim 16, wherein the display screen is motor-pivotable.

18. Simulator according to claim 16, wherein the display screen can be pivoted by a pneumatic or hydraulic cylinder.

19. Simulator according to claim 1, wherein the display screen is held in an abutment in its display position.

20. Simulator according to claim 1, wherein the display screen can be locked in the display position.

21. Simulator according to claim 20 in conjunction with a pivotable display screen, wherein the locking mechanism has a reception part and a plug-in part, which can be firmly interconnected by a locking pin which can be passed vertically through both of them.

22. Simulator according to claim 20, wherein a locking mechanism with an abutting surface and a locking rod having a recess, as well as a hook-like rocking lever pretensioned in spring-loaded manner towards the locking rod.

23. Simulator according to claim 22, wherein the locking mechanism has a reception part and a locking pin provided with a signal pin, locking being produced by a contact pressure.

24. Simulator according to claim 6, in conjunction with claim 5, characterized by a video projector.

25. Simulator according to claim 24, wherein the projector is vibration-neutralized with respect to the projection screen.

26. Simulator according to claim 24, wherein the projector is pivotable at the outside of the seat unit about a symmetry axis of the projection screen in reproduction position-parallel axis into a position in which the optical axis of the projector substantially coincides with the symmetry axis of the projection screen.

27. Simulator according to claim 1, characterized by a sound reproduction system associated with the seat unit.
